(19) United States
(12) Patent Application Publication
(10) Pub. No.: US 2026/0073753 A1
(43) Pub. Date: Mar. 12, 2026

(54) SYNCHRONIZING GRAPHICAL DATA WITH IMAGE DATA ASSOCIATED WITH A ROULETTE WHEEL

(71) Applicant: Interblock d.o.o., MENGES (SI)

(72) Inventors: James PRESTON, Macau (MO); Andrej TOMELJAK, Preserje pri Radomljah (SI); Urban BERGANT, Kamnik (SI); Tomaž FINK, Kamnik (SI)

(21) Appl. No.: 18/828,241

(22) Filed: Sep. 9, 2024

(51) Int. Cl. G07F 17/32

(52) U.S. Cl. CPC G07F 17/3211

(57) ABSTRACT

A roulette wheel having a rotating roulette wheel including upper and bottom surfaces, pockets on the upper surfaces and symbols arranged around and corresponding to the pockets. Triggers on the bottom surfaces trigger sensors. A computer receives sensor data and image data from video images of the upper surfaces, extrapolates rotational data associated with a location of each pocket from the sensor data, outputs the rotational data embedded in the image data, and generates random data. Player stations enable players to play by selecting symbols and generating playing data based on the symbol selection. Each player station receives the rotational data embedded in the image data, generates graphical data based on the random data and the playing data, and displays the graphical data on a display overlayed on the image data and synchronized to movement of the upper surfaces in the image data based on the rotational data.

### TECHNICAL FIELD

The present disclosure relates to a gaming apparatus and more particularly to a roulette gaming apparatus or systems and methods for using the same.

### BACKGROUND

Roulette is a popular game played in gaming establishments. In mechanical versions of the game (versus purely video generated), a roulette ball is launched into a stationary rim having an annular track encircling a spinning roulette wheel. The spinning wheel rotates in the opposite direction of the spinning roulette ball. The roulette ball spins around the annular track until friction between the roulette ball and the annular track and gravity cause the ball to lose momentum. Upon losing sufficient momentum, the roulette ball exits the annular track and falls on to the roulette wheel.

Between the track and the roulette wheel, the roulette ball may engage with one or more ball stops (or canoes) intervening between the annular track and the roulette wheel, causing the ball to jump about. Eventually, the roulette ball will come to rest in one of the numerous equally spaced ball slots located along a circumference of the roulette wheel. Each ball slot among the equally spaced ball slots is isolated from adjacent ball slots by separators positioned radially outward and corresponds to a particular number and color. The particular number represents a result for the game cycle that began when the roulette ball was launched.

As the roulette ball comes to rest, a marker (or dolly) may be used to mark a betting area (or layout) of a display or a physical horizontal surface that is separate from the roulette mechanism. The dolly identifies the particular number and color on the layout corresponding to the ball slot in which the roulette ball came to rest. Winning and losing selections for that game cycle that had been electronically or physically placed on the selection area prior to a selection close time of that game cycle are then determined according to the result. Once the losing and winning selections are resolved, a new game cycle starts.

Although roulette can be fun and exciting on its own, there have been numerous attempts to add further fun and excitement by modifying aspects of roulette as structured in different parts of the world. Roulette systems may include a quantity of numbers on the number circle spaced apart and arranged in different manners. The number circles of roulette wheels typically include at least 36 numbers. Some number circles may include additional numbers, and the roulette wheels may include a corresponding number of ball slots, which can change the arrangement of the numbers of the number circle. Number circles including an extra number are typically numbered “0”, two extra numbers are typically numbered “0 ” and “00”, etc. The “0 ” and “00” numbers are typically green and therefore neither even nor odd. Their usage may depend on the jurisdiction where the roulette wheel is located.

One visual modification may include projecting image data onto the roulette wheel or on to a display associated with the roulette wheel, such as a player station for use by a player of that roulette wheel. The image data may include images of the roulette wheel as it is spinning, the layout or both, and may include additional information, such as images of the winning selection, the amounts bet or won, various animations, bonus information, betting volume information, etc. Sometimes it is necessary to synchronize the image data with the physical movement of the roulette wheel. Prior solutions for synchronizing image data with roulette wheel movement rely on image capture, recognition and synthesis analysis and processing to track the roulette ball and the pockets of the roulette wheel and to generate the image data. This type of image analysis and processing can be computationally expensive and time consuming, making it less suitable for higher quality, real-time applications.

### SUMMARY

A roulette wheel system and method for synchronizing graphical data with image data of a rotating roulette wheel are disclosed. The rotating roulette wheel includes upper and bottom surfaces, pockets on the upper surfaces and symbols arranged around and corresponding to the pockets. Triggers on the bottom surfaces trigger sensors as the pockets rotate. A computer receives sensor data and image data from video images of the upper surfaces, extrapolates rotational data associated with a location of each pocket from the sensor data, outputs the rotational data embedded in the image data, and generates random data. Player stations enable players to play by selecting symbols and generating playing data based on the symbol selection. Each player station receives the rotational data embedded in the image data, generates graphical data based on the random data and the playing data, and displays the graphical data on a display overlayed on the image data and synchronized to movement of the upper surfaces in the image data based on the rotational data.

Additional systems and methods may include a non-transitory computer-readable medium comprising instructions to be executed by at least one processor. Such instructions may include obtaining image data of a rotating roulette wheel, the rotating roulette wheel including upper surfaces and bottom surfaces and a circle of pockets arranged on the upper surfaces, wherein a circle of symbols encircles the circle of pockets such that each symbol in the circle of symbols corresponds to one of the pockets in the circle of pockets, and a plurality of triggering devices arranged on at least one of the bottom surfaces, wherein during a game cycle a roulette ball launched into a stationary rim having an annular track encircling the rotating roulette wheel lands in a pocket indicating a conclusion of the game cycle, wherein each of the pockets is configured to hold the roulette ball at the conclusion of the game cycle; obtaining sensor data from one or more sensors triggerable by each triggering device among the plurality of triggering devices; extrapolating rotational data associated with a location of each pocket from the sensor data; embed the rotational data in the image data; outputting the rotational data embedded in the image data; generating random data; generating graphical data at a plurality of player stations, each player station among the plurality of player stations enabling players to play during the game cycle by selecting one or more of the symbols and generating playing data based on the symbol selection, each player station among the plurality of player stations receiving the rotational data embedded in the image data based on the random data and the playing data; and displaying the graphical data on a display of each player station overlayed on the image data and synchronized to movement of the upper surfaces in the image data based on the rotational data.

These and other features will be more clearly understood from the following detailed description taken in conjunction with the accompanying drawings and claims. This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a perspective view of a roulette wheel system in accordance with an embodiment.

FIG. 2 is a cross-sectional side view of a roulette wheel system in accordance with an embodiment.

FIG. 3 is an illustration of pegs and sensors under a roulette wheel and graphs illustrating readings of rotational data from the sensors in accordance with an embodiment.

FIG. 4 is an illustration of a computer within the roulette wheel system and an extrapolation of the rotational data from the sensors performed by the computer in accordance with an embodiment.

FIG. 5 is an illustration of image data associated with a roulette wheel in accordance with an embodiment.

FIG. 6 is an illustration of rotational data embedded in a video stream and an overlay composition of image data in accordance with an embodiment.

FIG. 7 is an illustration of synchronized image data overlayed on a video stream of the roulette wheel in accordance with an embodiment.

FIG. 8 is a further illustration of synchronized image data overlayed on a video stream of the roulette wheel in accordance with an embodiment.

FIG. 9 is an example operation method in accordance with an embodiment.

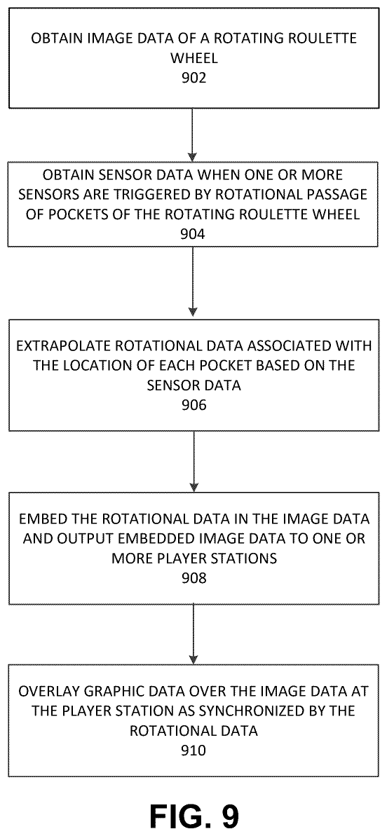

FIG. 10 is a block diagram of an embodiment of a computer system.

### DETAILED DESCRIPTION OF ILLUSTRATIVE EMBODIMENTS

The present disclosure describes particular embodiments and their detailed construction and operation. The embodiments described herein are set forth by way of illustration only and not limitation. Those skilled in the art will recognize, in light of the discussions herein, that there may be a range of equivalents to the exemplary embodiments described herein. Most notably, other embodiments are possible; variations can be made to the embodiments described herein; and there may be equivalents to the components, parts, or steps that make up the described embodiments. For the sake of clarity and conciseness, certain aspects of components or steps of certain embodiments are presented without undue detail where such detail would be apparent to those skilled in the art in light of the discussions herein and/or where such detail would obfuscate an understanding of more pertinent aspects of the embodiments.

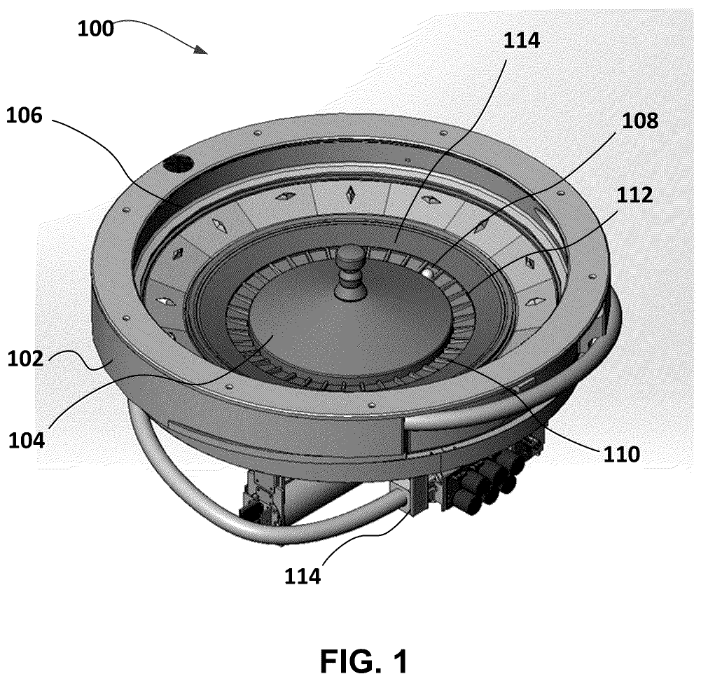

As shown in FIG. 1, most roulette wheel systems or mechanisms 100 have upper surfaces containing a base 102, a cone 104, a stationary rim 106 around which a ball 108 travels (the ball 108 is shown after it has stopped travelling), and a rotating roulette wheel 110 positioned in the middle of the base and having pockets 112 into which the ball 108 eventually falls and stops. The rotating roulette wheel 110 includes a circle of pockets 112 configured to hold the roulette ball 108. The pockets 112 are numbered on a circle of symbols or a number wheel 114 (shown blank) between 0 and 36 (and also 00 on some roulette wheels) and a color (typically green for 0 and 00 and alternating between red and black for the other numbers).

The numbering or illustration of the circle of symbols 114 may be physically applied (i.e., printed, painted, embedded, etc.) or visually applied through the projection of images onto the circle of symbols 114 or through lighting embedded in or under the circle of symbols 114. The circle of symbols 114 rotates with the rotating roulette wheel 110 and separate from the stationary rim 106. The stationary rim 106 may include an angled annular track in the upper surfaces in which a roulette ball may be spun and a slopping area around which the ball travels after leaving the track. The slopping area may include a number of bumps or canoes that generate further randomization of the ball's movement. At the beginning of a game cycle, typically after further selections are closed, a dealer will either manually spin the roulette ball in the track or the roulette ball will be launched from a launch tube of a launch mechanism 116. The roulette ball spins in the opposite direction of the rotation of the rotating roulette wheel. When the roulette ball eventually exits the track, the ball will ultimately land in one of the pockets indicating the end of that game cycle.

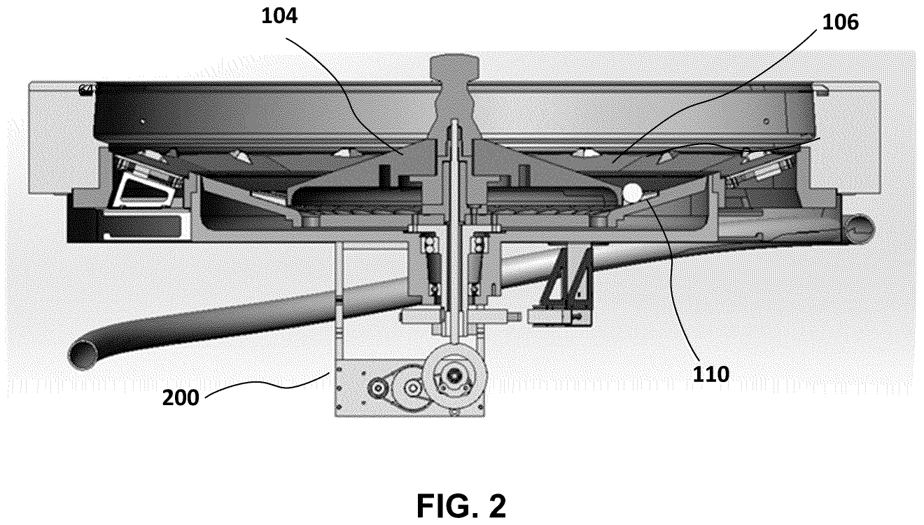

FIG. 2 further illustrates how the rotating roulette wheel 110 may be rotated by a rotation mechanism 200 and is separated from the stationary rim 106. The cone 104 may be configured to rotate with the rotating roulette wheel 110 or be stationary depending on how the rotation mechanism is configured.

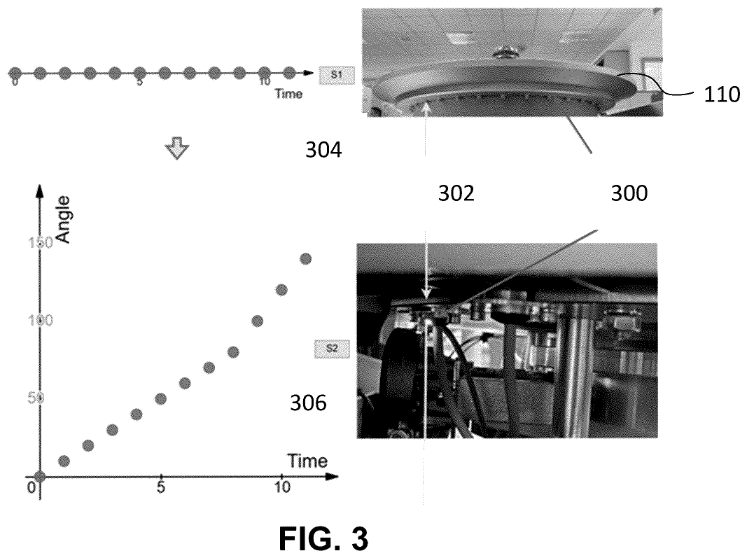

FIG. 3 illustrates a series of pegs 300 that may be positioned on bottom surfaces or an underside of the rotating roulette wheel 110 of a roulette wheel system 100. In an embodiment, there may be a peg 300 that corresponds to each of the pockets 112 such that rotation of the pegs is the equivalent to rotation of the pockets. One or more sensors 302, which may also be positioned on or near the bottom surfaces underneath the rotating roulette wheel 110 along with other mechanical and electrical components of the roulette wheel system 100. The chart 304 illustrates how each of the one or more sensors 302 may be triggered for every peg 300 that passes on the rotating roulette wheel 110. The chart 306 illustrates that the rotating roulette wheel's angular position may be calculated by reading data from the triggered sensors 302 as the pegs 300 pass the sensors 302 as the rotating roulette wheel 110 is spinning. Other triggering devices, aside from pegs may be used, such as magnets or other devices that may be suitable for triggering a sensor.

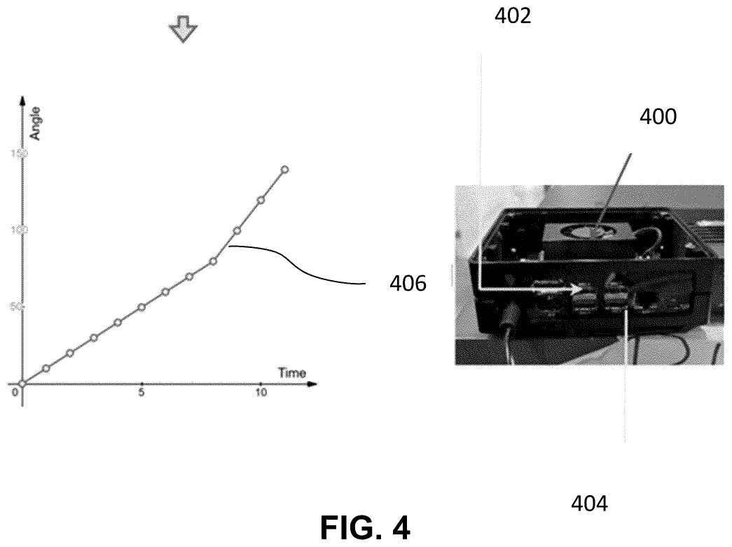

As illustrated in FIG. 4, a computer 400 positioned underneath the rotating roulette wheel 110 along with other mechanical and electrical components of the roulette wheel system 100, receives electrical pulses 402 from each of the sensors corresponding to the position of the pegs 300, and therefore the position of the pockets 112, and extrapolates the sensor data in order to determine rotational data 406, which includes the exact location of the roulette wheel's rotation at any give time. At the same time, the computer 400 may receive image data, such as a video stream, from a camera (not shown) positioned over the rotating roulette wheel 110 that illustrates the rotating roulette wheel as it is in use, such as when it is first spun, when a ball is launched, as the ball spins around the stationary rim, and as the ball falls out of the annular track of the stationary rim and falls onto the rotating roulette wheel and eventually into a pocket. The computer 400 then embeds the rotational data into the video stream and outputs the embedded image data 404 to one or more player stations.

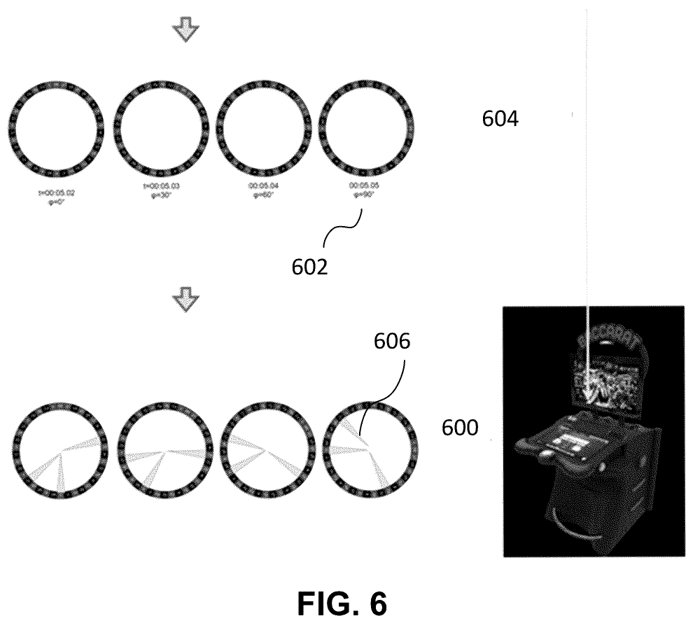

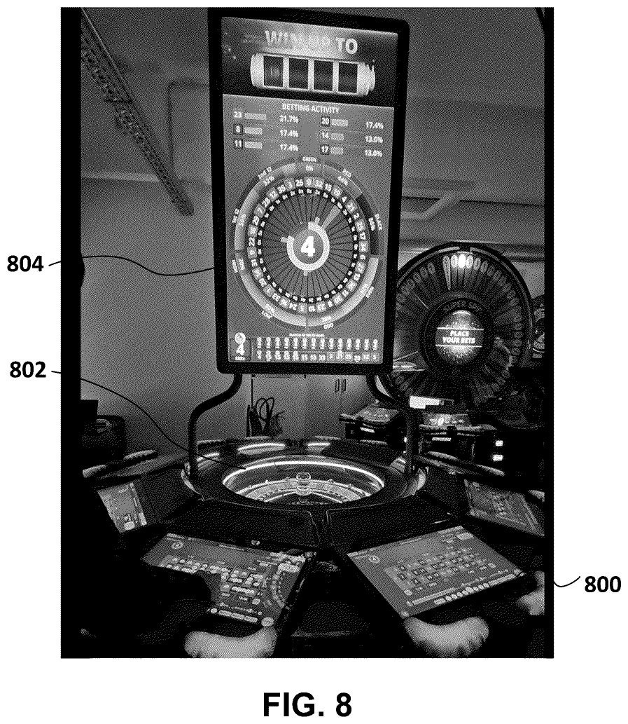

The one or more player stations, such as the player station 600 shown in FIG. 6, includes computing resources, a display, and various input/output devices that enable a user or player to play roulette games from the player station. As further illustrated with respect to FIG. 8, there may be multiple player stations 800 organized around the roulette wheel system 802.

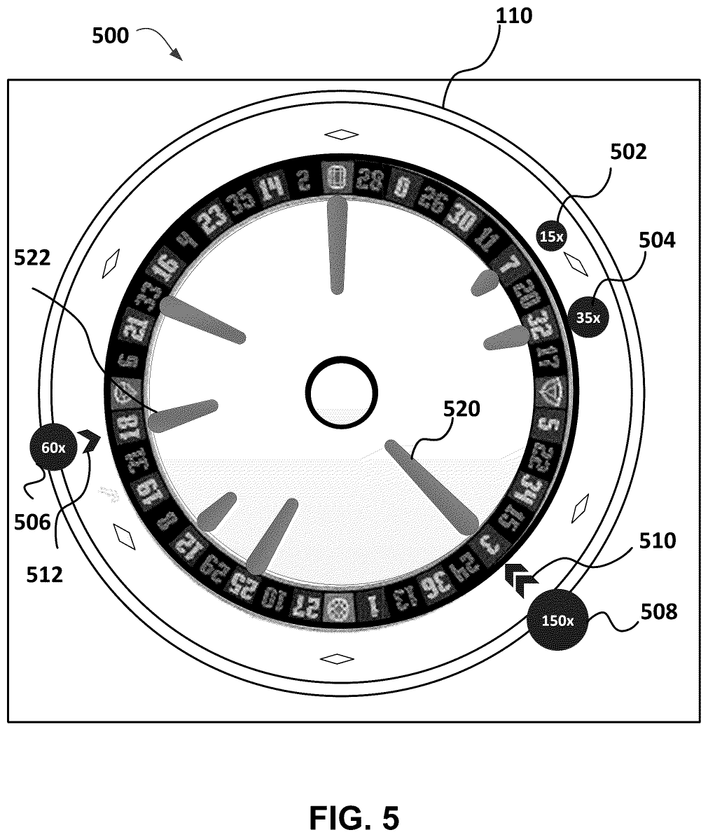

FIG. 5 illustrates an image 500 of the rotating roulette wheel 110 captured by the video stream and that includes graphical data, such as a number of graphical images, overlayed on the image 500 using the rotational data. The graphical data may include one or more symbols, including but not limited to various shapes, texts, numbers, and the like, each with optional brightness levels, sizes, and colors. The graphical data may include one or more multiplier symbols 502, 504, 506, 508 that indicate one or more multiplier values. The multipliers, both in terms of how many and their volume, may be generated by the computer 400 based on one or more pay tables associated with the game. Which symbols the multipliers are assigned to for each game may be randomly assigned by the computer and is referred to as random data, which may include other data as well.

The random data in the form of multiplier assignments may correspond to one or more numbers in a next round of play and identify which potential outcomes will receive the multiplier, if selected. In the illustrated example, roulette numbers 7, 32, 18, and 3 are associated, respectively, with 15×, 35×, 60×, and 155× multiplier values. A multiplier symbol, e.g., symbols 502, 504, 506, 508, may be overlayed on the video the rotating roulette wheel to indicate its multiplier value and the associated roulette number. The multiplier symbol may vary in shape, size, color, and text to draw attention to different aspects, such as a value of the multiplier. For example, symbol 508, which indicates a 150× multiplier, is larger in size than symbol 502, which indicates a 15× multiplier. Additional symbols, such as symbols 510, 512, may be overlayed to further highlight one or more of the multiplier values. Symbols 510, 512, for example, may draw attention to outcomes with the highest multiplier values. Symbol 510, showing two arrows, may indicate a greater multiplier value than symbol 712, showing a single arrow. Symbols 510 and 512 may therefore provide a quick, easily identifiable visual icon to a user to indicate a relative value of a multiplier. Such symbols may enable a user to distinguish between multiplier values quickly and thereby enhance the speed at which the user decides on and places a bet. Any of a plurality of symbols may be included to enable a player to easily identify relevant multiplier values and associated outcomes.

Dynamic bet indicators 520 and 522 may be projected onto a top, center portion of the roulette wheel. The bet indicators 520 and 522 may reflect playing data, such as volume data of current bets entered by players at play stations during a betting window, to visually show players where bets are being placed by other players. Volume data may include how many bets are placed on each symbol and/or the accumulative total of bets placed on each symbol. The bet indicators 520 and 522 may be a bar, blocks, lines, or any other symbol, provided in any of a variety of colors, shapes, sizes, and animations, which may dynamically adjust as bets are placed during the betting window. In examples, the bet indicators 520 and 522 may increase in length as additional bets are added. The bet indicators 520 and 522 may also change, e.g., increase in length, based a bet value associated with the number. For example, bet indicator 520 may indicate, based on its length, that the total amount wagered on number 3 is greater than any other numbers or symbols. The dynamic bet indicators may enable a user to quickly identify where bets are being placed. Dynamic bet indicators may also enhance the speed at which the user may decide to place a bet.

In an example, a first bet entered at a first outcome (e.g., number 7) may cause a first bet indicator symbol to be provided on the roulette wheel surface. A second bet entered at the first outcome may cause the bet indicator symbol to change. The bet indicator may change a shape, length, color, appearance, and the like. A second bet entered at number 7, for example, may cause the bet indicator symbol associated with number 7 to grow, e.g., similar to the bet indicator symbol on number 12.

In additional examples, a random selection may determine each value of the set of multiplier values. The set of roulette numbers to be associated with a multiplier value may also be randomly selected. In some examples the random selections may be associated with a pay table. Certain multipliers, for example, may have a higher probability of appearing, whereas other multipliers, such as higher-valued multipliers, may have a lower probability of appearing.

FIG. 6 illustrates how rotational data 602 may be combined with image data 604 to accurately track pockets (and corresponding numbers) of the rotating roulette wheels. A player station 600 may then overlay graphical data 606 on the image data 604 in synchronization with the rotational data 602 such at graphical data related to one particular number rotates with the appropriately corresponding number of the corresponding pocket.

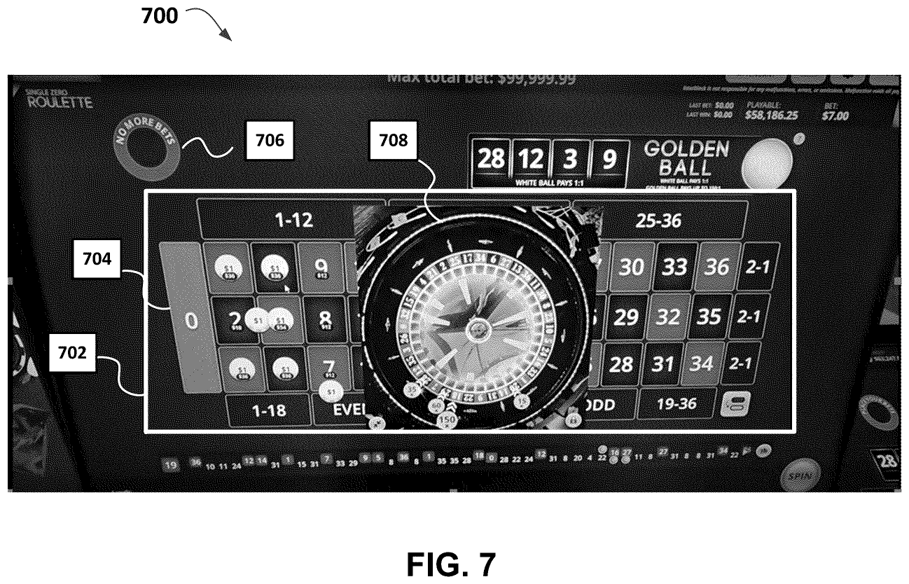

FIG. 7 illustrates an example interactive user interface 700 on a user device (e.g., a player station 600), which may be associated with various aspects described herein. The interactive user interface 700 may include a betting layout 702 including an arrangement of selections 704 corresponding to a game outcome. The selections 704 may correspond to numbers, symbols, colors, etc. associated with a roulette wheel. Some examples may include numbers 0 or 00 roulette variations, and include 36, 37, or more outcomes. In some examples, the selections 704 may be touch-sensitive when provided on an interactive user interface with a touch screen. One or more selections on the betting layout 702 may be selected during a betting window.

A betting window indicator 706 may provide one or more visual cues for time left to select bets. The betting window indicator 706 may provide a countdown indicating, e.g., how many seconds are left. The symbol may also change colors, e.g., green to yellow to red, to indicate that time is running out to place bets.

A streamed video with a graphic data overlay 708 may provide a live view of the roulette wheel. A camera may capture the roulette wheel and stream the video in real time to the user device for display on the interactive user interface 700. The streamed video may show graphic effects overlayed on a top surface of the roulette wheel (see, e.g., FIG. 5). The streamed video may be provided on various locations on the interactive user interface 700. In some examples, a user may drag and drop the streamed video 708 to different locations, based on preferences. In other examples, the streamed video 708 may automatically appear after the betting window has closed. The interactive user interface 700 may provide additional options to change the shape, size, and appearance to the streamed video 708. FIG. 8 illustrate example of multiple player stations 800 arranged around a roulette wheel system 802. Each of the player stations has a display and input/output devices that enable the players to play the roulette game, but each player station 800 also shares a common display, i.e. community display 804, that displays the image data synchronized with the rotational data along with the graphic data overlayed on the image data.

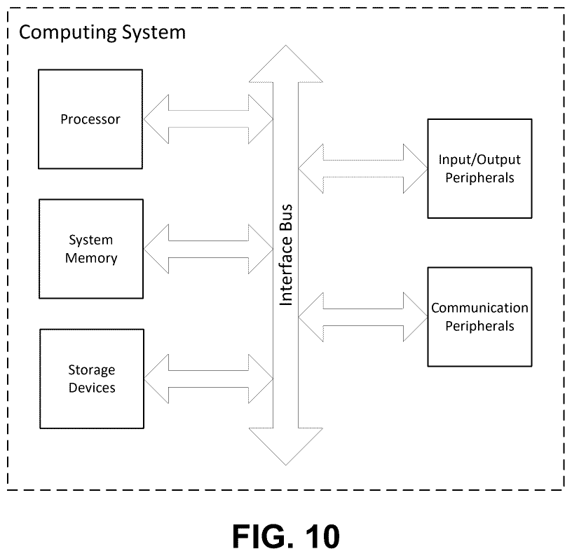

FIG. 10 illustrates a flow chart of operations in accordance with various aspects discussed herein. At block 902, image data is obtained of the rotating roulette wheel. This may be video data acquired from a camera positioned to monitor the rotating roulette wheel. This image data may be sent to the onboard computer 400 of the roulette wheel system or to a remotely located computer over a network. At block 904, sensor data is obtained when one or more sensors are trigged by the rotational passage of the pockets of the rotating roulette wheel. The sensor data is sent to the computer. Each of the pockets may correspond to a peg or other object that triggers the sensor as it passes. Alternatively, other optical sensing may be utilized to detect when a pocket has moved and to generate the sensor data.

At block 906, the rotational data may be extrapolated from the sensor data by the computer to determine the position or location at any time of each the pockets. At block 908, that rotational data may then be embedded into the image data or otherwise associated with the image data so it is possible to correlate the exact location of each pocket in real-time or near real-time as the rotating roulette wheel rotates. At block 910, the embedded image data is then displayed on a player station with graphics overlayed on the image data as synchronized by the embedded rotational data.

The present disclosure describes particular embodiments and their detailed construction and operation. The embodiments described herein are set forth by way of illustration only and not limitation. Those skilled in the art will recognize, in light of the discussions herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the discussions herein and/or where such detail would obfuscate an understanding of more pertinent aspects of the embodiments.

Some of the techniques described above can be implemented on a computing device associated with a gaming device (e.g., a roulette mechanism), a plurality of computing devices associated with a plurality of gaming devices, a controller in communication with the gaming device(s) (e.g., a controller configured to synchronize the gaming devices(s)), or a plurality of controllers in communication with the gaming device(s). Additionally, some of the techniques may be distributed between the computing device(s) and the controller(s). FIG. 10 illustrates an exemplary block diagram of a computing system that includes hardware modules, software module, and a combination thereof and that can be implemented as the computing device and/or as the server.

In a basic configuration, the computing system may include at least a processor, a system memory, a storage device, input/output peripherals, communication peripherals, and an interface bus. Instructions stored in the memory may be executed by the processor to perform a variety of methods and operations, including the shooter selection and console mirroring, as described above. The computing system components may be present in the gaming device, in a server or other component of a network, or distributed between some combinations of such devices.

The interface bus is configured to communicate, transmit, and transfer data, controls, and commands between the various components of the electronic device. The system memory and the storage device comprise computer-readable storage media, such as RAM, ROM, EEPROM, hard-drives, CD-ROMs, optical storage devices, magnetic storage devices, flash memory, and other tangible storage media. Any of such computer readable storage medium can be configured to store instructions or program codes embodying aspects of the disclosure. Additionally, the system memory comprises an operation system and applications. The processor is configured to execute the stored instructions and can comprise, for example, a logical processing unit, a microprocessor, a digital signal processor, and the like.

The system memory and the storage device may also comprise computer-readable signal media. A computer-readable signal medium may include a propagated data signal with computer-readable program code embodied therein. Such a propagated signal may take any of variety of forms including, but not limited to, electro-magnetic, optical, or any combination thereof. A computer-readable signal medium may be any computer-readable medium that is not a computer-readable storage medium and that can communicate, propagate, or transport a program for use in connection with the computing system.

Further, the input and output peripherals include user interfaces such as a keyboard, screen, microphone, speaker, other input/output devices, and computing components such as digital-to-analog and analog-to-digital converters, graphical processing units, serial ports, parallel ports, and universal serial bus. The input/output peripherals may also include a variety of sensors, such as light, proximity, GPS, magnetic field, altitude, velocity/acceleration, RSSI, and distance sensors, as well as other types of sensors. The input/output peripherals may be connected to the processor through any of the ports coupled to the interface bus.

The user interfaces can be configured to allow a user of the computing system to interact with the computing system. For example, the computing system may include instructions that, when executed, cause the computing system to generate a user interface and carry out other methods and operations that the user can use to provide input to the computing system and to receive an output from the computing system.

This user interface may be in the form of a graphical user interface that is rendered at the screen and that is coupled with audio transmitted on the speaker and microphone and input received at the keyboard. In an embodiment, the user interface can be locally generated at the computing system. In another embodiment, the user interface may be hosted on a remote computing system and rendered at the computing device. For example, the server may generate the user interface and may transmit information related thereto to the computing device that, in turn, renders the user interface to the user. The computing device may, for example, execute a browser or an application that exposes an application program interface (API) at the server to access the user interface hosted on the server.

Finally, the communication peripherals of the computing system are configured to facilitate communication between the computing system and other computing systems (e.g., between the computing device and the server) over a communications network. The communication peripherals include, for example, a network interface controller, modem, various modulators/demodulators and encoders/decoders, wireless and wired interface cards, antennas, and the like.

The communication network includes a network of any type that is suitable for providing communications between the computing device and the server and may comprise a combination of discrete networks which may use different technologies. For example, the communications network includes a cellular network, a Wi-Fi/broadband network, a local area network (LAN), a wide area network (WAN), a telephony network, a fiber-optic network, or combinations thereof. In an example embodiment, the communication network includes the Internet and any networks adapted to communicate with the Internet. The communications network may be also configured as a means for transmitting data between the computing device and the server.

The techniques described above may be embodied in, and fully or partially automated by, code modules executed by one or more computers or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage such as volatile or non-volatile storage.

In an embodiment, a roulette wheel system, comprising: a rotating roulette wheel including upper surfaces and bottom surfaces, a circle of pockets arranged on the upper surfaces, wherein a circle of symbols is arranged around the circle of pockets such that each of the symbols in the circle of symbols corresponds to one of the pockets in the circle of pockets, and a plurality of triggering devices arranged on at least one of the bottom surfaces, wherein during a game cycle a roulette ball launched into a stationary rim having an annular track encircling the rotating roulette wheel lands in a pocket indicating a conclusion of the game cycle, each of the pockets configured to hold the roulette ball at the conclusion of the game cycle; one or more sensors triggerable by each triggering device among the plurality of triggering devices; a computer receiving sensor data from the one or more sensors and image data from video images of the upper surfaces, extrapolating rotational data associated with a location of each pocket from the sensor data, outputting the rotational data embedded in the image data, and generating random data; and a plurality of player stations, each player station among the plurality of player stations enabling players to play during the game cycle by selecting one or more of the symbols and generating playing data based on the symbol selection, each player station among the plurality of player stations receiving the rotational data embedded in the image data, generating graphical data based on the random data and the playing data, and displaying the graphical data on a display overlayed on the image data and synchronized to movement of the upper surfaces in the image data based on the rotational data.

In the embodiment, wherein the plurality of triggering devices are pins, wherein each pin corresponds to one of the pockets.

In the embodiment, wherein the plurality of triggering devices are magnetic, wherein each triggering device among the plurality of triggering devices corresponds to one of the pockets.

In the embodiment, wherein the playing data includes volume data associated with the symbol selection.

In the embodiment, wherein the volume data is represented in the graphical data, wherein a first graphic image corresponding to the volume data is a first size when the volume data is a first level and wherein a second graphic image corresponding to the volume data is a second size when the volume data is a second level, wherein the second level is greater than the first level.

In the embodiment, wherein the graphical data corresponds to one or more multipliers that apply to some of the symbols based on the random data, wherein each multiplier among the one or more multipliers increases a value associated with a corresponding symbol.

In the embodiment, wherein a first graphic image corresponding to a first multiplier is a first size and a second graphic images corresponding to a second multiplier is a second size, wherein the second graphic image is larger than the first graphic image.

In the embodiment, wherein a third graphic image highlights the first multiplier and fourth graphic image highlights the second multiplier, the fourth graphic image highlighting the second multiplier more than the third graphic image highlights the first multiplier.

In the embodiment, wherein a first graphic image highlights a first multiplier and second graphic image highlights a second multiplier, the second graphic image highlighting the second multiplier more than the first graphic image highlights the first multiplier.

In the embodiment, wherein the random data includes the symbol to which each multiplier among the one or more multipliers applies.

In an embodiment, method of synchronizing graphical data with image data, comprising: obtaining image data of a rotating roulette wheel, the rotating roulette wheel including upper surfaces and bottom surfaces and a circle of pockets arranged on the upper surfaces, wherein a circle of symbols encircles the circle of pockets such that each symbol in the circle of symbols corresponds to one of the pockets in the circle of pockets, and a plurality of triggering devices arranged on at least one of the bottom surfaces, wherein during a game cycle a roulette ball launched into a stationary rim having an annular track encircling the rotating roulette wheel lands in a pocket indicating a conclusion of the game cycle, wherein each of the pockets is configured to hold the roulette ball at the conclusion of the game cycle; obtaining sensor data from one or more sensors triggerable by each triggering device among the plurality of triggering devices; extrapolating rotational data associated with a location of each pocket from the sensor data; embed the rotational data in the image data; outputting the rotational data embedded in the image data; generating random data; generating graphical data at a plurality of player stations, each player station among the plurality of player stations enabling players to play during the game cycle by selecting one or more of the symbols and generating playing data based on the symbol selection, each player station among the plurality of player stations receiving the rotational data embedded in the image data based on the random data and the playing data; and displaying the graphical data on a display of each player station overlayed on the image data and synchronized to movement of the upper surfaces in the image data based on the rotational data.

In the embodiment, wherein the plurality of triggering devices are pins, wherein each pin corresponds to one of the pockets.

In the embodiment, wherein the plurality of triggering devices are magnetic, wherein each triggering device among the plurality of triggering devices corresponds to one of the pockets.

In the embodiment, wherein the playing data includes volume data associated with the symbol selection.

In the embodiment, wherein the volume data is represented in the graphical data, wherein a first graphic image corresponding to the volume data is a first size when the volume data is a first level and wherein a second graphic image corresponding to the volume data is a second size when the volume data is a second level, wherein the second level is greater than the first level.

In the embodiment, wherein the random data is represented in the graphical data corresponds to one or more multipliers that apply to some of the symbols, wherein each multiplier among the one or more multipliers increases a value associated with a corresponding symbol.

In the embodiment, wherein a first graphic image corresponding to a first multiplier is a first size and a second graphic images corresponding to a second multiplier is a second size, wherein the second graphic image is larger than the first graphic image.

In the embodiment, wherein a third graphic image highlights the first multiplier and fourth graphic image highlights the second multiplier, the fourth graphic image highlighting the second multiplier more than the third graphic image highlights the first multiplier.

In the embodiment, wherein a first graphic image highlights a first multiplier and second graphic image highlights a second multiplier, the second graphic image highlighting the second multiplier more than the first graphic image highlights the first multiplier.

In the embodiment, wherein the random data includes the symbol to which each multiplier among the one or more multipliers applies.

As previously noted, the various features and processes described above may be used independently of one another or may be combined in various ways. All possible combinations and subcombinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

The present disclosure describes particular embodiments and their detailed construction and operation. The embodiments described herein are set forth by way of illustration only and not limitation. Those skilled in the art will recognize, in light of the discussions herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the discussions herein and/or where such detail would obfuscate an understanding of more pertinent aspects of the embodiments.

The terms and descriptions used above are set forth by way of illustration only and are not meant as limitations. Those skilled in the art will recognize that those and many other variations, enhancements, and modifications of the concepts described herein are possible without departing from the underlying principles of the invention. The scope of the invention should therefore be determined only by the following claims and their equivalents.

What is claimed:

1. A roulette wheel system, comprising:
a rotating roulette wheel including upper surfaces and bottom surfaces, a circle of pockets arranged on the upper surfaces, wherein a circle of symbols is arranged around the circle of pockets such that each of the symbols in the circle of symbols corresponds to one of the pockets in the circle of pockets, and a plurality of triggering devices arranged on at least one of the bottom surfaces, wherein during a game cycle a roulette ball launched into a stationary rim having an annular track encircling the rotating roulette wheel lands in a pocket indicating a conclusion of the game cycle, each of the pockets configured to hold the roulette ball at the conclusion of the game cycle;
one or more sensors triggerable by each triggering device among the plurality of triggering devices;
a computer receiving sensor data from the one or more sensors and image data from video images of the upper surfaces, extrapolating rotational data associated with a location of each pocket from the sensor data, outputting the rotational data embedded in the image data, and generating random data; and
a plurality of player stations, each player station among the plurality of player stations enabling players to play during the game cycle by selecting one or more of the symbols and generating playing data based on the symbol selection, each player station among the plurality of player stations receiving the rotational data embedded in the image data, generating graphical data based on the random data and the playing data, and displaying the graphical data on a display overlayed on the image data and synchronized to movement of the upper surfaces in the image data based on the rotational data.

2. The roulette wheel system of claim 1, wherein the plurality of triggering devices are pins, wherein each pin corresponds to one of the pockets.

3. The roulette wheel system of claim 1, wherein the plurality of triggering devices are magnetic, wherein each triggering device among the plurality of triggering devices corresponds to one of the pockets.

4. The roulette wheel system of claim 1, wherein the playing data includes volume data associated with the symbol selection.

5. The roulette wheel system of claim 4, wherein the volume data is represented in the graphical data, wherein a first graphic image corresponding to the volume data is a first size when the volume data is a first level and wherein a second graphic image corresponding to the volume data is a second size when the volume data is a second level, wherein the second level is greater than the first level.

6. The roulette wheel system of claim 1, wherein the graphical data corresponds to one or more multipliers that apply to some of the symbols based on the random data, wherein each multiplier among the one or more multipliers increases a value associated with a corresponding symbol.

7. The roulette wheel system of claim 6, wherein a first graphic image corresponding to a first multiplier is a first size and a second graphic images corresponding to a second multiplier is a second size, wherein the second graphic image is larger than the first graphic image.

8. The roulette wheel system of claim 7, wherein a third graphic image highlights the first multiplier and fourth graphic image highlights the second multiplier, the fourth graphic image highlighting the second multiplier more than the third graphic image highlights the first multiplier.

9. The roulette wheel system of claim 6, wherein a first graphic image highlights a first multiplier and second graphic image highlights a second multiplier, the second graphic image highlighting the second multiplier more than the first graphic image highlights the first multiplier.

10. The roulette wheel system of claim 6, wherein the random data includes the symbol to which each multiplier among the one or more multipliers applies.

11. A method of synchronizing graphical data with image data, comprising:
obtaining image data of a rotating roulette wheel, the rotating roulette wheel including upper surfaces and bottom surfaces and a circle of pockets arranged on the upper surfaces, wherein a circle of symbols encircles the circle of pockets such that each symbol in the circle of symbols corresponds to one of the pockets in the circle of pockets, and a plurality of triggering devices arranged on at least one of the bottom surfaces, wherein during a game cycle a roulette ball launched into a stationary rim having an annular track encircling the rotating roulette wheel lands in a pocket indicating a conclusion of the game cycle, wherein each of the pockets is configured to hold the roulette ball at the conclusion of the game cycle;
obtaining sensor data from one or more sensors triggerable by each triggering device among the plurality of triggering devices;
extrapolating rotational data associated with a location of each pocket from the sensor data;
embed the rotational data in the image data;
outputting the rotational data embedded in the image data;
generating random data;
generating graphical data at a plurality of player stations, each player station among the plurality of player stations enabling players to play during the game cycle by selecting one or more of the symbols and generating playing data based on the symbol selection, each player station among the plurality of player stations receiving the rotational data embedded in the image data based on the random data and the playing data; and
displaying the graphical data on a display of each player station overlayed on the image data and synchronized to movement of the upper surfaces in the image data based on the rotational data.

12. The method of claim 11, wherein the plurality of triggering devices are pins, wherein each pin corresponds to one of the pockets.

13. The method of claim 11, wherein the plurality of triggering devices are magnetic, wherein each triggering device among the plurality of triggering devices corresponds to one of the pockets.

14. The method of claim 11, wherein the playing data includes volume data associated with the symbol selection.

15. The method of claim 14, wherein the volume data is represented in the graphical data, wherein a first graphic image corresponding to the volume data is a first size when the volume data is a first level and wherein a second graphic image corresponding to the volume data is a second size when the volume data is a second level, wherein the second level is greater than the first level.

16. The method of claim 11, wherein the random data is represented in the graphical data corresponds to one or more multipliers that apply to some of the symbols, wherein each multiplier among the one or more multipliers increases a value associated with a corresponding symbol.

17. The method of claim 16, wherein a first graphic image corresponding to a first multiplier is a first size and a second graphic images corresponding to a second multiplier is a second size, wherein the second graphic image is larger than the first graphic image.

18. The method of claim 17, wherein a third graphic image highlights the first multiplier and fourth graphic image highlights the second multiplier, the fourth graphic image highlighting the second multiplier more than the third graphic image highlights the first multiplier.

19. The method of claim 16, wherein a first graphic image highlights a first multiplier and second graphic image highlights a second multiplier, the second graphic image highlighting the second multiplier more than the first graphic image highlights the first multiplier.

20. The method of claim 16, wherein the random data includes the symbol to which each multiplier among the one or more multipliers applies.
